(19) United States
(12) Patent Application Publication
(10) Pub. No.: US 2024/0028943 A1
(43) Pub. Date: Jan. 25, 2024

(54) COMPILATION OF HYBRID QUANTUM COMPUTING PROGRAMS

(71) Applicant: Xanadu Quantum Technologies Inc., Toronto (CA)

(72) Inventors: Joshua Izaac, Toronto (CA); Nathan Killoran, Toronto (CA); David Ittah, Toronto (CA); Samuel Banning, Toronto (CA)

(21) Appl. No.: 18/356,319

(22) Filed: Jul. 21, 2023

Related U.S. Application Data
(60) Provisional application No. 63/391,927, filed on Jul. 25, 2022.

(51) Int. Cl. G06N 10/80; G06N 10/20

(52) U.S. Cl. CPC G06N 10/80; G06N 10/20

(57) ABSTRACT

A system, method, and computer program product for optimizing quantum computer programs using multi-level intermediate representations are provided. An intermediate representation of a high-level quantum program defined in a high-level programming language can be determined. An optimized version of the intermediate representation can be generated according to optimization transformations. The optimization transformations can be associated with an intermediate numerical representation or an intermediate quantum representation. The optimized versions of the intermediate representations can then be used to generate a compiled quantum program that can be used for execution by quantum hardware and/or a quantum simulator.

### CROSS REFERENCE TO RELATED APPLICATIONS

This application claims the benefit of U.S. Provisional Patent Application Ser. No. 63/391,927, filed Jul. 25, 2022, the entire contents of which is hereby incorporated by reference.

### FIELD

This document relates to systems and methods for processing quantum computer programs. In particular, this document relates to systems and methods for optimizing quantum computer programs using multi-level intermediate representations.

### BACKGROUND

Intermediate representations (IR) are pervasive in computer science and programming. The goal of an IR is to represent the source code of a computer program—typically written in a high-level programming language—such that:
it is an accurate representation of the original source code;
it is independent of the original source code programming language;
it is independent of the target computer architecture; and
the generated IR data structure is conducive to static analysis and optimization.

As a result, IRs are typically used in compiler workflows, in order to (a) allow multiple source languages to generate low-level machine code for multiple architectures, and (b) enable optimization of the code during compilation. Well-known compilation architectures that involve the use of IRs include the Low Level Virtual Machine (LLVM) framework.

### SUMMARY

The following summary is intended to introduce the reader to various aspects of the detailed description, but not to define or delimit any invention.

Systems, methods and computer program products for optimizing quantum computer programs using multi-level intermediate representations are provided. More particularly, in some examples, an intermediate representation of a high-level quantum program can be determined. An optimized version of the intermediate representation can be generated according to optimization transformations. The optimization transformations can be associated with an intermediate numerical representation or an intermediate quantum representation. The optimized versions of the intermediate representations can then be used to generate a compiled quantum program that can be used for execution by quantum hardware and/or a quantum simulator.

According to some aspects, the present disclosure provides a method comprising: determining an intermediate representation of a high-level quantum program representation defined in a high-level programming language, the intermediate representation comprising a first portion and a second portion; optimizing the intermediate representation by optimizing the first portion of the intermediate representation according to a first set of optimization transformations associated with the first portion of the intermediate representation, thereby generating a first optimized version of the intermediate representation; further optimizing the intermediate representation by optimizing the second portion of the intermediate representation according to a second set of optimization transformations associated with the second portion of the intermediate representation, thereby generating a second optimized version of the intermediate representation; wherein one of the first portion or the second portion is an intermediate numerical representation usable to optimize numerical characteristics of the high-level quantum program representation; and the other of the first portion or the second portion is an intermediate quantum representation usable to optimize quantum characteristics of the high-level quantum program representation.

The first portion of the intermediate representation can be the intermediate numerical representation.

The first portion of the intermediate representation can be the intermediate quantum representation.

The method can include further optimizing the intermediate representation of the high-level quantum program using a third set of optimization transformations associated with the first portion of the intermediate representation.

The method can include further optimizing the intermediate representation of the high-level quantum program using a fourth set of optimization transformations associated with the second portion of the intermediate representation.

Optimizing the second one of the first portion of the intermediate representation and the second portion of the intermediate representation can comprise generating at least one new intermediate quantum program representation, each new intermediate quantum program representation representing a new quantum program that is different from an original quantum program corresponding to the high-level quantum program representation.

The at least one new intermediate quantum program representation can include a plurality of new intermediate quantum program representations.

The at least one new intermediate quantum program representation can include a transformed intermediate quantum program representation corresponding to a transformation of the original quantum program.

The method can further include determining at least one additional version of the intermediate representation of the high-level quantum program from the second optimized version of the intermediate representation, the at least one additional version of the intermediate representation including a lower-level intermediate representation; and generating a third optimized version of the intermediate representation by optimizing the lower-level intermediate representation.

The method can further include generating a compiled quantum program for execution based at least in part on the third optimized version of the intermediate representation.

The intermediate numerical representation can be defined to directly represent differentiable tensor values.

The high-level quantum program representation can represent a hybrid quantum-classical program, and at least one of the optimization transformations can comprise computing a gradient of both the classical portion and quantum portion of the hybrid quantum-classical program.

The high-level quantum program representation can represent a hybrid quantum-classical program.

The intermediate representation can include control flow data, and the optimization transformations can be performed taking into account the control flow data.

The control flow data can be modified by at least one of the optimization transformations.

According to some aspects, there is provided a non-transitory computer readable medium storing computer-executable instructions, which, when executed by a computer processor, cause the computer processor to carry out a method that includes: determining an intermediate representation of a high-level quantum program representation defined in a high-level programming language, the intermediate representation comprising a first portion and a second portion; optimizing the intermediate representation by optimizing the first portion of the intermediate representation according to a first set of optimization transformations associated with the first portion of the intermediate representation, thereby generating a first optimized version of the intermediate representation; further optimizing the intermediate representation by optimizing the second portion of the intermediate representation according to a second set of optimization transformations associated with the second portion of the intermediate representation, thereby generating a second optimized version of the intermediate representation; wherein one of the first portion or the second portion is an intermediate numerical representation usable to optimize numerical characteristics of the high-level quantum program representation; and the other of the first portion or the second portion is an intermediate quantum representation usable to optimize quantum characteristics of the high-level quantum program representation.

The first portion of the intermediate representation can be the intermediate numerical representation.

The first portion of the intermediate representation can be the intermediate quantum representation.

The method can include further optimizing the intermediate representation of the high-level quantum program using a third set of optimization transformations associated with the first portion of the intermediate representation.

The method can include further optimizing the intermediate representation of the high-level quantum program using a fourth set of optimization transformations associated with the second portion of the intermediate representation.

Optimizing the second one of the first portion of the intermediate representation and the second portion of the intermediate representation can comprise generating at least one new intermediate quantum program representation, each new intermediate quantum program representation representing a new quantum program that is different from an original quantum program corresponding to the high-level quantum program representation.

The at least one new intermediate quantum program representation can include a plurality of new intermediate quantum program representations.

The at least one new intermediate quantum program representation can include a transformed intermediate quantum program representation corresponding to a transformation of the original quantum program.

The method can further include determining at least one additional version of the intermediate representation of the high-level quantum program from the second optimized version of the intermediate representation, the at least one additional version of the intermediate representation including a lower-level intermediate representation; and generating a third optimized version of the intermediate representation by optimizing the lower-level intermediate representation.

The method can further include generating a compiled quantum program for execution based at least in part on the third optimized version of the intermediate representation.

The intermediate numerical representation can be defined to directly represent differentiable tensor values.

The high-level quantum program representation can represent a hybrid quantum-classical program, and at least one of the optimization transformations can comprise computing a gradient of both the classical portion and quantum portion of the hybrid quantum-classical program.

The high-level quantum program representation can represent a hybrid quantum-classical program.

The intermediate representation can include control flow data, and the optimization transformations can be performed taking into account the control flow data.

The control flow data can be modified by at least one of the optimization transformations.

According to some aspects, there is also provided a computer system comprising a processor, a computer-readable memory, and a non-transitory computer readable medium storing computer-executable instructions, which, when executed by the processor, cause the processor to carry out a method comprising: determining an intermediate representation of a high-level quantum program representation defined in a high-level programming language, the intermediate representation comprising a first portion and a second portion; optimizing the intermediate representation by optimizing the first portion of the intermediate representation according to a first set of optimization transformations associated with the first portion of the intermediate representation, thereby generating a first optimized version of the intermediate representation; further optimizing the intermediate representation by optimizing the second portion of the intermediate representation according to a second set of optimization transformations associated with the second portion of the intermediate representation, thereby generating a second optimized version of the intermediate representation; wherein one of the first portion or the second portion is an intermediate numerical representation usable to optimize numerical characteristics of the high-level quantum program representation; and the other of the first portion or the second portion is an intermediate quantum representation usable to optimize quantum characteristics of the high-level quantum program representation.

The first portion of the intermediate representation can be the intermediate numerical representation.

The first portion of the intermediate representation can be the intermediate quantum representation.

The method can include further optimizing the intermediate representation of the high-level quantum program using a third set of optimization transformations associated with the first portion of the intermediate representation.

The method can include further optimizing the intermediate representation of the high-level quantum program using a fourth set of optimization transformations associated with the second portion of the intermediate representation.

Optimizing the second one of the first portion of the intermediate representation and the second portion of the intermediate representation can comprise generating at least one new intermediate quantum program representation, each new intermediate quantum program representation representing a new quantum program that is different from an original quantum program corresponding to the high-level quantum program representation.

The at least one new intermediate quantum program representation can include a plurality of new intermediate quantum program representations.

The at least one new intermediate quantum program representation can include a transformed intermediate quantum program representation corresponding to a transformation of the original quantum program.

The method can further include determining at least one additional version of the intermediate representation of the high-level quantum program from the second optimized version of the intermediate representation, the at least one additional version of the intermediate representation including a lower-level intermediate representation; and generating a third optimized version of the intermediate representation by optimizing the lower-level intermediate representation.

The method can further include generating a compiled quantum program for execution based at least in part on the third optimized version of the intermediate representation.

The intermediate numerical representation can be defined to directly represent differentiable tensor values.

The high-level quantum program representation can represent a hybrid quantum-classical program, and at least one of the optimization transformations can comprise computing a gradient of both the classical portion and quantum portion of the hybrid quantum-classical program.

The high-level quantum program representation can represent a hybrid quantum-classical program.

The intermediate representation can include control flow data, and the optimization transformations can be performed taking into account the control flow data.

The control flow data can be modified by at least one of the optimization transformations.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a block diagram illustrating an example system for cloud-based quantum computing;

FIG. 2 is a diagram illustrating an example program flow for processing quantum programs;

FIG. 3 is a flowchart illustrating an example of a method for optimizing a quantum program using multi-level intermediate representations;

FIG. 4 is a flowchart illustrating an example of a method for optimizing a quantum program using a lower-level intermediate representation; and

FIG. 5 is a flowchart illustrating an example program flow for optimizing a quantum program using multi-level intermediate representations.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

The terms “coupled” or “coupling” as used herein can have several different meanings depending on the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, electrical signal, or a mechanical element depending on the particular context. Furthermore, the term “communicative coupling” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The systems, methods, and devices described herein may be implemented as a combination of hardware or software. In some cases, the systems, methods, and devices described herein may be implemented, at least in part, by using one or more computer programs, executing on one or more programmable devices including at least one processing element, and a data storage element (including volatile and non-volatile memory and/or storage elements). These devices may also have at least one input device (e.g. a pushbutton keyboard, mouse, a touchscreen, and the like), and at least one output device (e.g. a display screen, a printer, a wireless radio, and the like) depending on the nature of the device.

Some elements that are used to implement at least part of the systems, methods, and devices described herein may be implemented via software that is written in a high-level procedural language such as object-oriented programming. Accordingly, the program code may be written in any suitable programming language such as Python or C for example. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

The present disclosure relates to a system, method, and computer program product for optimizing quantum computer programs using multi-level intermediate representations. More particularly, in some examples, an intermediate representation of a high-level quantum program can be determined. An optimized version of the intermediate representation can be generated according to optimization transformations. The optimization transformations can be associated with an intermediate numerical representation or an intermediate quantum representation. The optimized version of the intermediate representations can then be used to generate a compiled quantum program that can be used for execution by quantum hardware and/or a quantum simulator.

The systems and methods of the present disclosure can ensure that quantum and numerical data is represented and optimized through multi-level intermediate representations with minimal information loss in the process. This can ensure that the optimized and compiled program that is ultimately executed more accurately reflects the intended operations of the quantum program as it was originally defined in the high-level programming language.

Providing an optimized version of the quantum program can also be useful where the quantum computer program (or quantum circuit derived therefrom) needs to be stored for later execution (e.g. because there is a job queue for the quantum hardware) and/or where the quantum program is being sent to a remote (e.g. cloud-based) quantum computing system for execution.

Various different types of optimizations can be performed on the intermediate representation(s) of the quantum program. For example, certain optimizations can be defined to reduce the number of qubits required to execute the quantum program. This may help ensure that the quantum program can be run on available quantum hardware. Alternatively, or in addition, optimizations can be defined to reduce the number of quantum gates required by the quantum program. This can minimize noise and error when the quantum program is executed on quantum hardware. Alternatively, or in addition, optimizations can be defined to minimize the classical representation of a hybrid quantum-classical program. This may reduce the data size required to represent the quantum-classical program, which can reduce overhead involved in transmitting or storing the quantum program.

As quantum hardware and the associated quantum circuits and quantum computer programs become more complex, the volume of data required to represent a given quantum computer program increases. Efficiently representing a quantum computer program can also help reduce the parsing overhead involved in storing a quantum computer program or generating a quantum circuit before it runs on quantum hardware and/or quantum simulators.

Currently, quantum computing hardware is expensive, and access is limited. It is often impractical for individual users to directly access quantum computing hardware in order to run quantum computer programs. As a result, access to quantum computing hardware is often provided in a cloud environment over a network. Examples of cloud-based quantum computing systems include the Xanadu Cloud and the IBM Q Experience among many others. As more advanced quantum hardware becomes available through cloud services, the need to represent advanced quantum computer programs with many parameters (e.g., numerical and quantum) in a manner that is both human-readable and efficient grows in tandem.

Many quantum computer programs involve elements of classical computing in the form of hybrid quantum-classical computer programs. A hybrid quantum-classical computer program is a computer program that is written (or designed) to be run in part on a classical computing device and in part on a quantum computing device. A well-known example of a hybrid quantum-classical computer program is Shor's algorithm, which has (a) a classical part that reduces a factoring problem to an order-finding problem; and (b) a quantum part that solves the order-finding problem (using a quantum Fourier transform). In such a case, a hybrid quantum-classical computer program may be sent to be run, at least in part, on the quantum computing hardware.

Hybrid quantum-classical computer programs can also involve more complicated interactions between the classical and quantum portions of the program. Hybrid quantum-classical program can include dependencies between the quantum and classical portions of the program. For example, a quantum program can be defined to include (1) executing a quantum circuit using quantum hardware or a quantum simulator; (2) providing the output of the quantum circuit into a classical algorithm executed using classical computer components; (3) providing the output of the classical algorithm into one or more dependent quantum circuits; and (4) executing the one or more dependent quantum circuits. There may also be many iterations or dependency relationships within a single hybrid program. Various techniques can be used to separate the classical components of the computer program from the quantum components of the computer program in order to optimize the operation of the different components of the quantum-classical computer program or the program as a whole.

The various examples described herein may be applied equally to pure quantum computer programs as well as hybrid quantum-classical computer programs. Any reference to quantum computer programs in the examples described herein can therefore be understood as applying either to pure quantum computer programs or to hybrid quantum-classical computer programs.

Providers of quantum computing services typically transpile quantum computer programs before running them. The process of transpiling a quantum computer program can involve rewriting a quantum circuit to match the topology of the quantum hardware that the quantum computer program will run on. Transpilation can include an optimization process, where the quantum program or its execution is simplified so as to reduce the risks of quantum decoherence during use. Reducing gate counts and run time for quantum computer programs can result in more accurate and more efficient algorithms.

Multi-Level Intermediate Representations (MLIRs) allow source code to be transformed (or “lowered”) through multiple IRs with each IR representing a different level (e.g., a lower level) of computation. MLIRs may provide a number of advantages, such as:
representing structures deemed too high level for LLVM IR (such as auto-differentiation graphs, arrays with dynamic shapes, custom operations);
including operations which might be specific to certain accelerators, and to mix and match different accelerators; and
allowing for optimization strategies that might be application specific, in particular those used in deep learning.

MLIR also enables progressively lowering IR “dialects” to take advantage of low-level compilation and optimization. For example, MLIR can be used to progressively lower high-level source code down to LLVM.

The present disclosure relates to systems and methods defined to effectively represent quantum instructions for execution on quantum hardware using multiple intermediate representation levels. The present disclosure also relates to the use of multiple intermediate representation levels to provide optimization of the components of quantum computer programs (including hybrid quantum-classical programs) and/or optimization of the control flow of the quantum computer program, as well as the use of multiple intermediate representation levels for more general hybrid quantum-classical frameworks that include translation between multiple quantum-enabled languages (QCOR, QASM, Quil), IRs (LLVM, QIR), and runtimes.

In existing optimization and compilation workflows, quantum instruction parameters are often treated as floating point values, and lowered directly to lower-level representations (e.g., LLVM) or machine code. However, this can result in the loss of important information relating to the operation of the quantum program. For example, fairly typical hybrid quantum-classical workflows involve both the quantum instruction parameters, and quantum hardware, being differentiable “tensors”. Casting these tensors to floating point values results in important information being lost regarding the classical component of the computation. Furthermore, machine learning libraries generating and manipulating these differentiable tensors may allow for MLIR support. Accordingly, lowering the source code to a purely quantum dialect may prevent optimization of the classical dataflow.

The present disclosure provides systems and methods for processing and optimizing quantum computer programs that can directly support quantum instructions to be executed on quantum hardware. The systems and methods of the present disclosure can support quantum compilation and optimization of the quantum instruction sets and account for dataflow optimization of surrounding classical control if necessary.

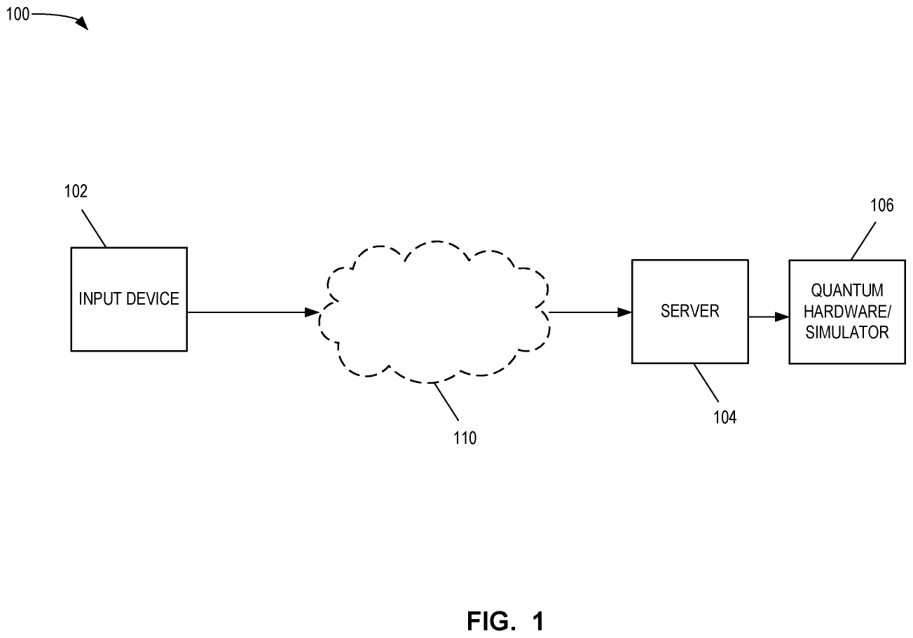

Referring now to FIG. 1, shown therein is a block diagram illustrating an example processing system 100. Processing system 100 is an example of a system that can be used to provide cloud-based quantum computing.

In the example illustrated, system 100 includes an input device 102, a server 104, and a quantum hardware/simulator 106. The input device 102 can be configured to define a representation of a quantum computer program (or “quantum program”) in a high-level programming level (e.g. Python). This high-level quantum program representation can be provided to the server 104 for optimization, compilation and execution via the quantum hardware/simulator 106.

Alternatively, the input device 102 may perform some processing of the high-level quantum program. For example, the input device 102 may translate the high-level quantum program into an intermediate representation that is then provided to the server 104 for further optimization, compilation and execution via the quantum hardware/simulator 106.

Alternatively, or in addition, the input device 102 may compile the quantum program representation before providing an intermediate representation of the compiled quantum program to the server 104. Alternatively, or in addition, the optimization of the quantum program can also be performed by the input device 102.

The input device 102 can be communicatively coupled with the server 104, e.g. using a wired or wireless communication module (e.g., Bluetooth, Bluetooth Low-Energy, WiFi, ANT+IEEE 802.11, etc.). The input device 102 can also be communicatively coupled to the server 104 over, for example, a wide area network 110 such as the Internet.

The input device 102 generally refers to any processing unit capable of providing a user interface to enable a user to define a high-level representation of a quantum program. The input device 102 can also provide a representation of the quantum program (e.g. the high-level representation or an intermediate representation) to the server 104. Alternatively, the input device 102 may provide an optimized and compiled quantum program directly to the quantum hardware/simulator 106 (e.g. where the quantum hardware/simulator is local to the input device 102).

The input device 102 can provide a user interface through a locally installed application that allows a user to define the high-level representation of the quantum programs locally on the input device 102. Alternatively, or in addition, the user interface may be provided through a web application or web browser accessible through the input device 102.

The input device 102 can be implemented using a processor such as a general purpose microprocessor. The processor controls the operation of the input device 102 and in general can be any suitable processor such as a microprocessor, controller, digital signal processor, field programmable gate array, application specific integrated circuit, microcontroller, or other suitable computer processor that can provide sufficient processing power, depending on the desired configuration, for the purposes and requirements of the system 100.

The input device 102 can include the processor, a power supply, memory, at least one input device (e.g. a pushbutton keyboard, mouse, a touchscreen, and the like), and at least one output device (e.g. a display screen) and a communication module operatively coupled to the processor. The memory unit can include RAM, ROM, one or more hard drives, one or more flash drives or some other suitable data storage elements such as disk drives, etc.

The server 104 can be implemented using a processor such as a general purpose microprocessor. The processor controls the operation of the server 104 and in general can be any suitable processor such as a microprocessor, controller, digital signal processor, field programmable gate array, application specific integrated circuit, microcontroller, or other suitable computer processor that can provide sufficient processing power, depending on the desired configuration, purposes and requirements of the system 100.

The server 104 can include the processor, a power supply, memory, and a communication module operatively coupled to the processor and to the quantum hardware/simulator 106. The memory can include RAM, ROM, one or more hard drives, one or more flash drives or some other suitable data storage elements such as disk drives, etc.

The server 104 can be communicatively coupled to one or more quantum hardware or simulator systems 106, e.g. using a wired or wireless communication module (e.g., Bluetooth, Bluetooth Low-Energy, WiFi, ANT+IEEE 802.11, etc.). The server 104 can also be communicatively coupled to quantum hardware or simulator systems 106 over, for example, a wide area network such as the Internet.

Optionally, the server 104 can be coupled directly to quantum hardware or simulator systems 106. For example, the quantum hardware or simulator systems 106 may be coupled to the communication module (and thereby the server 104) using a wired connection such as Universal Serial Bus (USB) or other port. Although shown separately, the quantum hardware or simulator systems 106 may be co-located or combined with, the server 104.

The quantum hardware or simulator systems 106 can be implemented using one or more quantum computing systems including quantum processors and/or quantum simulators and/or quantum emulators. Various different types of quantum computing systems can be used to provide the quantum hardware or simulator systems 106 depending on the implementation of system 100.

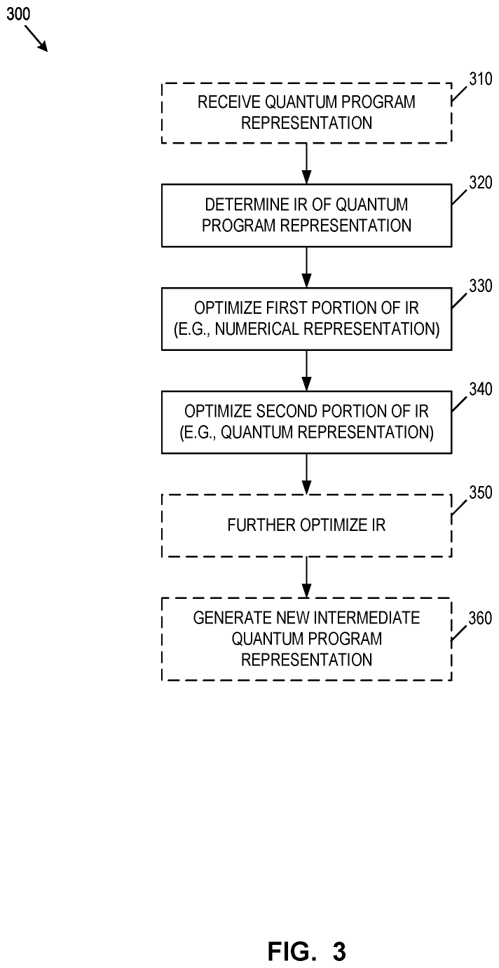

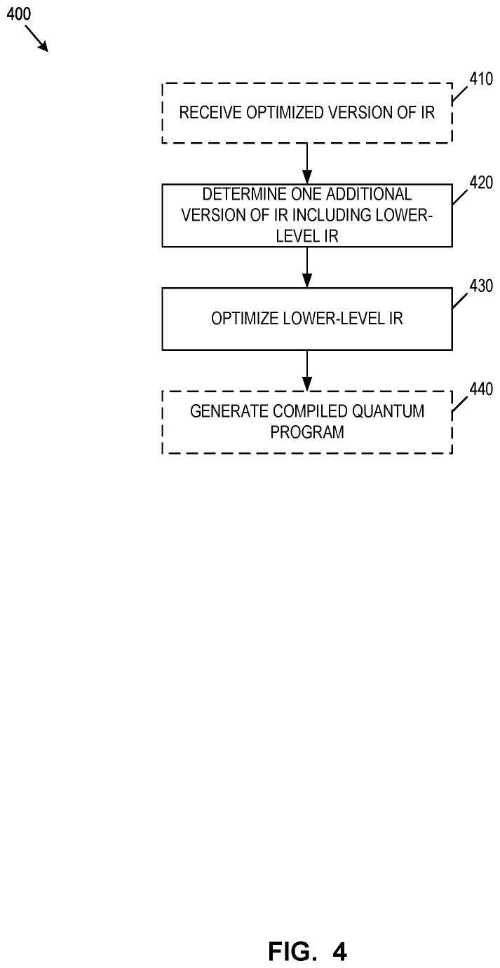

Components of system 100 can be configured to perform methods relating to the optimizing of intermediate representations of a quantum computer program, such as the example methods 300 and 400 shown in FIGS. 3 and 4 and described in further detail herein below. For example, the input device 102 and/or server 104 can be configured to perform some or all of the steps of methods 300 and/or 400 depending on the particular implementation.

Furthermore, it should be understood that although system 100 shows a cloud-based environment for quantum computing, the methods described herein can also be implemented using a local quantum computing system (e.g. where the quantum hardware/simulator 106) is local instead of remote. In such cases, the input device 102 may be coupled directly to quantum hardware or simulator systems 106 (the server 104 may be omitted and/or the functions of the server 104 may be combined with the functions of the input device 102).

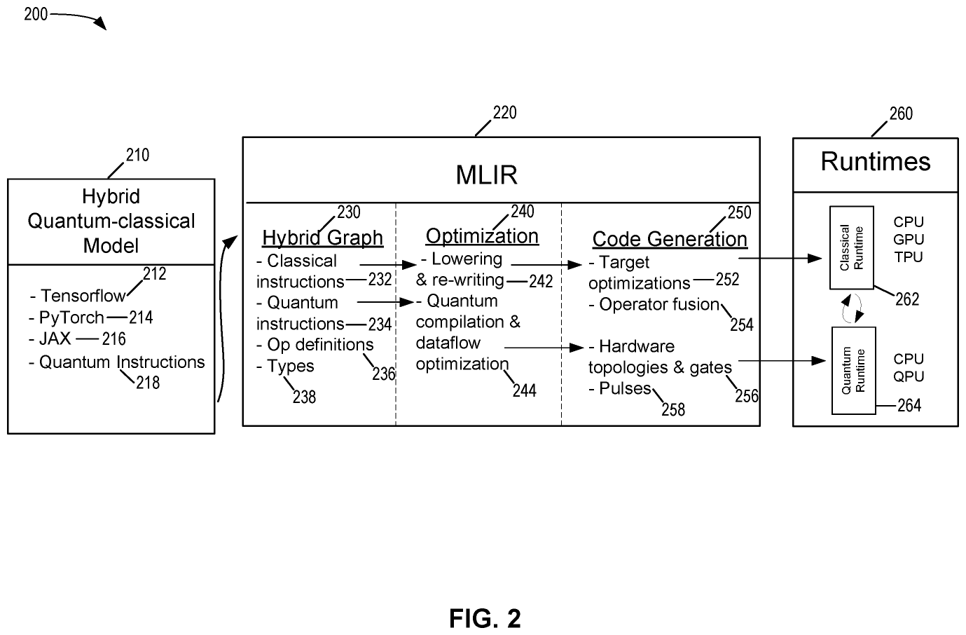

Referring now to FIG. 2, shown therein is a diagram of an example program flow 200 for processing quantum programs. In the example shown in FIG. 2, the program flow 200 is defined to process a hybrid quantum-classical computer program.

As shown, the program flow 200 has a hybrid quantum-classical model 210, a multi-level intermediate representation (MLIR) 220, and runtimes 260.

The hybrid quantum-classical model 210 includes a quantum program which can be represented as high-level source code, for example, in one or more of Tensorflow 212, PyTorch 214, JAX 216, or quantum instructions 218. Alternatively, or in addition, libraries that are specially designed for numerical, scientific, or quantum computing, such as NumPy, can be used for at least part of the high-level source code.

Once a high-level representation of the quantum program is defined at 210, the quantum program can be processed using the MLIR 220. The MLIR 220 can include multiple stages or levels of intermediate representations that can be used to optimize the quantum program for execution by quantum hardware or a quantum simulator.

In the example shown, MLIR 220 includes a hybrid graph 230, an optimization block 240, and a code generation block 250, which may be referred to as “stages”. The stages of MLIR 220 can perform various operations to define intermediate representations of the quantum program and to optimize the intermediate representations prior to execution. As discussed further herein below, the MLIR 220 is defined to ensure that quantum and numerical data from the high-level definition of the quantum program is accurately represented and optimized through multi-level intermediate representations with minimal information loss.

A hybrid graph 230 can be used to represent various components of the quantum program. The hybrid graph 230 can include, for example, one or more of classical instructions 232, quantum instructions 234, operator definitions 236, or types 238 depending on the nature of the quantum program being optimized. The components of the hybrid graph 230 can then be optimized through a series of optimization operations at optimization block 240 and code generation block 250.

The optimization block 240 defines optimization operations usable to generate multiple versions of intermediate representations of the quantum program, with each version resulting from optimization operations being performed on a preceding version of the intermediate representation. Each of the optimization operations can be defined to optimize one or more of the components identified by the hybrid graph 230. For example, as discussed further herein below, separate optimization operations may be used to optimize numerical aspects of a quantum program, quantum aspects of a quantum program, and/or control flow aspects of the quantum program.

The optimization block 240 can include optimization operations that involve, for example, lowering & re-writing 242 the intermediate representation of the quantum program, and/or quantum compilation & dataflow optimization 244 of the quantum program.

For example, lowering and re-writing the classical instructions 232 at 242 can include transforming (or “lowering”) the classical instructions 232 through multiple intermediate representations with each subsequent intermediate representation representing a lower level of computation.

Performing quantum compilation and dataflow optimization for the quantum instructions 234 at 244 can include compiling and optimizing quantum instruction sets, taking into account dataflow optimization of surrounding classical control. Examples of optimization operations are described in further detail herein below, for instance with reference to steps 330 and 340 of method 300.

The code generation block 250 can also include various operations defined to optimize the representation of the quantum program when the quantum program is ultimately compiled into code that is executable by the quantum hardware/simulator and/or classical computing elements. For example, the code generation block 250 can include one or more of hardware target optimizations 252, operator fusion 254, optimizations specific to hardware topologies & gates 256, and optimizations that utilize pulse-level representations 258, as well as other general quantum compilation operations.

Target optimizations 252 may include, for example, operations defined to optimize the classical instructions 232 based on the particular hardware that is being used to execute the classical instructions 232. The target optimizations 252 may be applied after the classical instructions have undergone lowering & rewriting at 242.

The operator fusion 254 may include, for example, operations defined to merge multiple instructions into one. This may be used in reducing computation requirements. The operator fusion 254 operations can also be applied after the classical instructions have undergone lowering & rewriting at 242.

Hardware topology & gate optimizations 256 can include, for example, operations defined to optimize the quantum instructions 234 based on the particular quantum hardware or simulator that is being used to execute the quantum instructions 234. The hardware optimizations 256 may be applied to the quantum instructions 234 during or after the quantum compilation & dataflow optimization operations. For example, the hardware optimizations 256 can include optimizations that are defined to account for a specific layout or connectivity of a particular quantum device. These optimization operations can also be implemented as constraints on other optimization operations.

Pulse optimizations 258 can include, for example, operations defined to optimize the quantum instructions 234 based on pulsed control instructions (“pulses”) that enact desired state transformations and/or measurements for the particular quantum device.

Once the representation of the quantum program has been optimized and compiled through the MLIR 220, the lower-level representation of the quantum program can be provided to runtimes 260. Runtimes 260 generally refer to the software modules that receive a compiled binary program as input and enable the program to be executed.

As shown in FIG. 2, the runtimes 260 include a classical runtime 262 and a quantum runtime 264. The classical runtime 262 is defined to execute the classical code (derived from the classical instructions 232) generated from the code generation block 250. The classical runtime 262 may run the classical code, for example, using one or more of a CPU, GPU, or TPU. The quantum runtime 264 is defined to execute the quantum code (derived from the quantum instructions 234) generated from the code generation block 250. The quantum runtime 264 may run the quantum code, for example, using one or more of a CPU or QPU.

The system 100 can use the MLIR 220 to perform an optimization method (such as those shown in FIGS. 3 and 4 described in further detail herein below). For example, the MLIR 220 may be considered to be dialects of the existing machine learning libraries, which are extended to directly support the quantum instructions 234 to be executed on quantum hardware by the quantum runtime 264. In addition, this quantum MLIR extension can support quantum compilation & dataflow optimization 244 of the quantum instructions 234 (or “quantum instruction sets”), taking into account dataflow optimization of surrounding classical control.

The runtimes 260 may be considered to be an extension to existing runtimes, which enable the quantum code (representing the quantum instructions 234) to be executed on available quantum hardware by the quantum runtime 264. The classical component of the computation (e.g., the classical code representing the classical instructions 232) can continue to be executed via existing runtime/compilation processes, but utilize callbacks to retrieve results of quantum computations where needed.

Referring now to FIG. 3, shown therein is an example method 300 for optimizing a quantum program using multi-level intermediate representations (IR).

The method 300 may be used with a system for processing quantum circuits such as the cloud-based system 100 for example. It should be understood that method 300 can also be used with other systems for processing quantum programs including non-cloud-based quantum execution systems.

Depending on the particular implementation, the method 300 can be implemented by one or more components of the system 100, such as the input device 102 and server 104. Optionally, all of the steps of method 300 may be performed at the input device 102 (e.g. prior to sending an intermediate representation of a quantum program to the server 104 for execution and/or prior to storing the intermediate representation of the quantum program).

Alternatively, some or all of the steps of method 300 may be performed by the server 104 (e.g. where the input device 102 is used to generate a high-level definition of a quantum program that is provided directly to the server 104 for execution). This may simplify the adoption of method 300 by existing quantum program processing systems, for instance where quantum execution jobs are normally represented by a single file.

Alternatively, or in addition, the steps of method 300 may be performed using a local quantum computing system instead of the example cloud-based quantum computing system shown in FIG. 1.

At 310, a high-level representation of a quantum program can be received. The high-level representation can be a high-level quantum circuit representation defined in a high-level programming language.

The high-level representation received at 310 can be a hybrid quantum-classical program. An example of pseudocode for a high-level representation of a quantum program (in this example a hybrid quantum-classical program) is shown here:

```
# high-level representation of quantum-classical program
def circuit(params: Tensor):
  for x in params:
    z = x ** 2 + x
    RZ(z, qubit=0)
    CNOT(qubit=[0, 1])
    PauliZ(qubit=0)
  return expval(PauliZ(qubit=1))
def workflow(params: Tensor):
  while circuit(params) != 1:
    idx = random_integer(0, len(params))
    params[idx] = (params[idx] + 0.1) % 2*PI
  return params
}
# ------------------------------------------------------------ #
```

Optionally, the high-level quantum program representation may be contained in at least one request message. The at least one request message can include a request to execute the corresponding quantum program represented by a high-level quantum circuit representation. For example, the at least one request message may be transmitted by a user input device (e.g. input device 102) to a server (e.g. server 104) that provides remote access to quantum hardware and/or a quantum simulator (e.g. quantum hardware/simulator 106).

Alternatively, or in addition, the high-level quantum program representation may be received through a user interface provided by the server 104. For example, the server 104 may provide a quantum circuit definition user interface (e.g. a web-based interface provided through a webpage or web app) that is accessible to the input device 102 e.g. over network 110. A user of input device 102 may interact with the quantum circuit definition interface to provide the high-level definition of the quantum program directly to the server interface.

Alternatively, the high-level quantum program representation may be received by the input device 102 (e.g. through a local quantum circuit definition application operating on the input device 102). A user of input device 102 may interact with the local quantum circuit definition interface to provide the high-level definition of the quantum program to the input device 102.

At 320, an intermediate representation of the quantum program representation can be determined. This may include determining an intermediate representation of a high-level quantum program representation defined in a high-level programming language received at 310.

The quantum program can include a plurality of program portions. The program portions can refer to different aspects of the program that can be optimized using multi-level intermediate representations (e.g. numerical aspects, quantum aspects, etc.). The plurality of program portions can include a first portion and a second portion. Optionally, the first portion may be a numerical portion while the second portion is a quantum portion. Alternatively, the first portion may be a quantum portion while the second portion is a numerical portion.

Accordingly, the intermediate representation can also include a plurality of intermediate representation portions. One portion of the intermediate representation can be an intermediate numerical representation usable to optimize numerical characteristics of the high-level quantum program representation. Another portion of the intermediate representation can be an intermediate quantum representation usable to optimize quantum characteristics of the high-level quantum program representation.

Stated another way, the plurality of intermediate representation portions can include a first portion and the second portion. One of the first portion and the second portion can be the intermediate numerical representation and the other of the first portion and the second portion can be the intermediate quantum representation.

An example of pseudocode for an intermediate representation of a quantum program, which is a hybrid quantum-classical program, is as follows:

```
# intermediate representation of quantum-classical program
func @circuit(%params: tensor<?xf32>, %qubits: register<?>) −>
tensor<f32> {
  # capture classical control flow
  %ub = tensor.length %params
  control.for %i = 0 to %ub {
    # belongs to first portion, numerical computation
    %x = tensor.extract %params[%i]
    %y = numeric.power %x, 2
    %z = numeric.add %y, %x
    # belongs to second portion, quantum computation
    quantum.RZ(%z) %qubits[0]
    quantum.CNOT %qubits[0], %qubits[1]
    quantum.PauliZ %qubits[0]
  }
  return quantum.expval(“PauliZ”) %qubits[1]
}
```

The intermediate representation of a high-level quantum program representation defined in a high-level programming language can be determined in various ways. Optionally, the intermediate representation can be determined by parsing the program instructions directly. For example, the program instructions can be parsed by directly inspecting the code (e.g., Python code) that was written (without executing it).

Alternatively, or in addition, a hybrid quantum-classical program embedded in a high-level programming language can be translated into an intermediate representation in a target language using language mapping. The source language can be identified as the high-level programming language with embedded domain-specific (quantum) instructions. The target language can be identified as the intermediate representation. An abstract syntax tree of the program can be built using the source language's native capabilities. The syntax tree may contain the instructions of the program broken up into the basic syntactic elements of the programming language, and can encode the relationship between each element. Traversing the tree from top to bottom, each syntactic element may be replaced with an equivalent syntactic element in the target language. This process can ensure that the quantum instructions, control flow, and basic classical instructions can be translated into the IR while preserving the relationships between them.

Optionally, special-purpose tensor computations can be isolated into separate functions and their translation can be staged out (i.e. performed as an independent translation operation). This can ensure that tensor values are maintained when being translated to the intermediate representation language (e.g. rather than casting tensor values to floating point values). The translation can then be performed via the tools provided by the respective tensor software libraries, which can use the same target language of the intermediate representation.

Alternatively, or in addition, determining an intermediate representation of a high-level quantum program representation defined in a high-level programming language can involve integrating with existing numerical libraries (e.g. JAX) that already support MLIR generation. This can be done using tracing methods. The high-level code (e.g., Python code) can be executed and the various program instructions that act on the inputs are recorded. This recording can then be used to generate the intermediate representation. JAX is a numeric tensor programming Python package. However, JAX can be treated as an “embedded language” within Python, or Embedded Domain-Specific Language (DSL). The JAX “language” (known as jaxpr) can be extended with quantum primitives to enable JAX to encode hybrid classical-quantum programs. The JAX encoding can then be lowered from jaxpr to the intermediate representation.

At 330, the first portion of the intermediate representation from 320 can be optimized. Optimizing the first portion of the intermediate representation can generate a first optimized version of the intermediate representation. This may include optimizing the first portion of the intermediate representation according to a first set of optimization transformations associated with the first portion of the intermediate representation. These optimizations may include transformations that reduce resource usage including optimizations of quantum gates such as removing unnecessary gates, gate fusion (e.g., combining two or more gates into a single gate), cancellation of constructive gates that are self-inverses, and commutation of controlled gates. Other optimizations may include algebraic optimizations, target optimizations, and operator fusion operations, for example.

The specific optimization performed can depend on the content of the first portion of the intermediate representation. For example, the first portion may be a numerical portion. In such cases, the numerical aspects of the quantum program may be optimized e.g. using algebraic optimizations.

Alternatively, the first portion may be a quantum portion. In such cases, the quantum aspects of the quantum program may be optimized e.g. by optimizing quantum gates as mentioned above.

An example of pseudocode representing a first optimized version of the intermediate representation is shown here:

```
# first optimized version of the intermediate representation
func @circuit(%params: tensor<?xf32>, %qubits: register<?>) −>
tensor<f32> {
  %ub = tensor.length %params
  control.for %i = 0 to %ub {
    # optimizing the numerical computation
    # multiply is generally more efficient than power
    %x = tensor.extract %params[%i]
    %y = numeric.multiply %x, %x
    %z = numeric.add %y, %x
    quantum.RZ(%z) %qubits[0]
    quantum.CNOT %qubits[0], %qubits[1]
    quantum.Pauliz %qubits[0]
  }
  return quantum.expval(“PauliZ”) %qubits[1]
}
# ------------------------------------------------------------ #
```

In the above example pseudocode, the first portion of the intermediate representation was identified as the numerical portion of the quantum program. In the example first optimized version of the intermediate representation, the numerical portion has been optimized by converting a power operation to a multiply operation.

The intermediate numerical representation can be defined to directly represent differentiable tensor values. This can ensure that the quantum program can be optimized with minimal loss of information as compared to existing processes that may convert tensor values to floating point values. Another example of pseudocode defining an intermediate representation in which the numerical portion includes function arguments that are differentiable tensors is shown here:

```
# function arguments are differentiable tensors
func @workflow(%params: tensor<?xf32>) {
  %qubits = quantum.allocate(1) : register<1>
  # belongs to first portion, numerical computation
  control.while {
    control.condition call @circuit(%params, %qubits)
  } do {
    %ub = tensor.length %params
    %idx = numeric.randomInteger(0, %ub)
    %tmp = numeric.add %y[%idx], 1.0
    %params[%idx] = numeric.modulo %tmp[%idx], 2PI
  }
  return %params
}
# ------------------------------------------------------------ #
```

Optionally, the high-level quantum program representation can represent a hybrid quantum-classical program. The optimization transformations can include combined optimization operations that are defined to optimize both the classical portion and quantum portion of the hybrid quantum-classical program.

For example, the optimization transformations can include computing a gradient of both the classical portion and quantum portion of the hybrid quantum-classical program. A quantum gradient may be computed, for example, when using a variational circuit. The output of a variational circuit is the expectation value of a measurement observable, which can be formally written as a parameterized “quantum function” ƒ(θ) in the tunable parameters θ=θ₁, θ₂, . . . . As with any other such function, one can define partial derivatives of ƒ with respect to its parameters. A quantum gradient can be determined as the vector of partial derivatives of a quantum function ƒ(θ) according to:

$${∇}_{θ} f ( θ ) = ( \begin{matrix}{\partial }_{{θ}_{1}} f \\ {\partial }_{{θ}_{2}} f \\ ⋮\end{matrix} )$$

In some cases, quantum nodes can be defined by several expectation values, for example if multiple qubits are measured. In such cases, the output is described by a vector-valued function \hat{ƒ}(θ)=(ƒ₁(θ), ƒ₁(θ), . . . )^{T}, and the quantum gradient becomes a “quantum Jacobian” as shown here:

$${J}_{θ} f ( θ ) = ( \begin{matrix}{\partial }_{{θ}_{1}} {f}_{1} & {\partial }_{{θ}_{1}} {f}_{2} & … \\ {\partial }_{{θ}_{2}} {f}_{1} & {\partial }_{{θ}_{2}} {f}_{2} & … \\ ⋮ & & ⋱\end{matrix} )$$

The gradient of a quantum function ƒ(θ) may be expressed as a linear combination of other quantum functions via parameter-shift rules. Accordingly, quantum gradients can be computed using quantum computers, opening up quantum computing to gradient-based optimization such as gradient descent, which is widely used in machine learning.

The following example shows a mechanism to compute quantum gradients at the IR level on a dynamically defined circuit.

A quantum program can be defined to include parameters and control flow in a high-level programming language (e.g., in Python):

```
def circuit(params: Annotated[Tensor, 1, float32]):
  for i in range(len(params)):
    RY(params[i], wires=i)
  return probs( )
```

The high-level representation can then be converted to an intermediate representation language (e.g., MLIR). Shown below is an example of the quantum IR representation of the circuit (using memory semantics on the quantum operations for simplicity):

```
func @circuit(%params: tensor<?xf32>, %qubits: register<?>) −>
tensor<?xf32> {
  %c0 = constant 0
  %lb = constant 0
  %st = constant 1
  %ub = tensor.dim %params, %c0
  control.for %i = %lb to %ub step %st {
    %x = tensor .extract %params[%]
    quantum.RX(%x) %qubits[%i]
  }
  return quantum.probs %qubits
}
```

The intermediate representation can then be optimized. For example, a numerical portion of the intermediate representation can be optimized to re-write the gradient of the circuit as explicit circuit executions. An auto-differentiation pass can be performed on the function using parameter-shift rules resulting in the original function shifting arguments. This auto-differentiation pass may be considered to be part of the optimizing of the intermediate representation according to a set of optimization associations associated with a portion of the intermediate representation. The optimized representation can thus include a new function defined to compute the gradients by invoking the original function with shifts. An example of pseudocode showing the optimized representation with the modified function that computes the gradients by invoking the original function with shifts is shown here (it should be noted that allocation/load/store is not how tensors work in MLIR; memory buffers work this way, but it simplifies the example):

```
func @circuit_shifted(%params: tensor<?xf32>, %qubits:
!quantum.qreg<?>, %it: index, %shift: f32) −> tensor<?xf32> {
  %c0 = constant 0
  %lb = constant 0
  %st = constant 1
  %ub = tensor.dim %params, %c0
  control.for %i = %lb to %ub step %st {
    %x = tensor.extract %params[%i]
    // apply shift only on iteration provided as argument
    %cond = control.compare “eq”, %i, %it
    %xs = control.if %cond {
      %x_shifted = numeric.addf %x, %shift
      yield %x_shifted
    } else {
      yield %x
    }
    quantum.RX(%xs) %q
  }
  return quantum.probs %qubits
}
func @circuit_grad(%params: tensor<?xf32>, %qubits: register<?>)
−> tensor<?x?xf32> {
  %c0 = constant 0
  // allocate gradient array, axes: # gate params, func output
  %num_params = tensor.dim %params, %c0
  %num_args = numeric.addi %c0, %num_params
  %num_qubits = quantum.dim %qubits
  %gradients = tensor.allocate(%num_args, %num_qubits) :
tensor<?x?xf32>
  // preserve loops in order to apply dynamic number of shifts
  %lb = constant 0
  %st = constant 1
  %ub = numeric.addi %num_params, %c0
  control.for %i = %lb to %ub step %st {
    // compute the parameter-shift gradient for each RX
    %neg = constant −1.0
    shift_p = constant 1.57079632679
    %shift_n = numeric.mulf %neg, $p_shift
    %r_p = call @circuit_shifted(%params, %qubits, %i,
%shift_p)
    %r_n = call @circuit_shifted(%params, %qubits, %i,
%shift_n)
    %diff = numeric.subf %r_p, %r_n
    %half = constant 0.5
    %g = numeric.mulf %diff, %half
    tensor.store %diff, %gradients[%i]
  }
  return %gradients
}
```

Optionally, the intermediate representation can include control flow data. The optimization transformations can be performed taking into account the control flow data. The control flow data may be modified by at least one of the optimization transformations.

At 340, a second portion of the intermediate representation can be optimized. Optimizing the second portion of the intermediate representation can generate a second optimized version of the intermediate representation. The second optimized version of the intermediate representation can be the version of the intermediate representation that results from performing the optimization(s) at step 330 and the optimization(s) at step 340.

At 340, the intermediate representation can be optimized according to a second set of optimization transformations associated with the second portion of the intermediate representation. For example, if the numerical portion of the intermediate representation was optimized at 330, then the quantum portion of the intermediate representation can be optimized at 340. Conversely, if the quantum portion of the intermediate representation was optimized at 330, then the numerical portion of the intermediate representation can be optimized at 340.

An example of pseudocode representing a second optimized version of the intermediate representation is shown here:

```
# second optimized version of the intermediate representation
func @circuit(%params: tensor<?xf32>, %qubits: register<?>) −>
tensor<f32> {
  %ub = tensor.length %params
  control.for %i = 0 to %ub {
    %x = tensor.extract %params[%i]
    %y = numeric.multiply %x, %x
    %z = numeric.add %y, %x
    # optimizing the quantum computation
    # substituting two rotation gates with new angle
    # (RZ + PauliZ)
    %new_z = numeric.add %z, PI
    quantum.RZ(%new_z) %qubits[0]
    quantum.CNOT %qubits[0], qubits[1]
  }
  return quantum.expval(“PauliZ”) %qubits[1]
}
# ------------------------------------------------------------ #
```

In the above example pseudocode, the second portion of the intermediate representation is the quantum portion. In the example second optimized version of the intermediate representation, the quantum portion has been optimized by substituting two rotation gates with a new angle.

As noted herein above, the optimization transformations can be defined to account for control flow data. In some cases, the control flow data can be modified by the optimization transformation.

An example of pseudocode representing a transformed intermediate quantum program representation (a transformation of the example second optimized version shown above), is shown here:

```
# transformation of the original program
func @circuit(%params: tensor<?xf32>, %qubits: register<?>) −>
tensor<f32> {
  %total = 0.0
  control.for %j = 0 to 1000 {
    %ub = tensor.length %params
    control.for %i = 0 to sub {
      %x = tensor.extract %params[%i]
      %y = numeric.multiply %x, %x
      %z = numeric.add %y, %x
      %new_z = numeric.add %z, PI
      quantum.RZ(%new_z) %qubits[0]
      quantum.CNOT %qubits[0], %qubits[1]
    }
    # quantum.expval is a high-level operation that has been
    # removed and replaced with a surrounding for-loop
    # sampling the quantum device and calculating an average
    %meas = quantum.measure %qubits[1]
    %total = numeric.add %total, %meas
  }
  # 1000 is a configurable value for expval lowering
  return numeric.divide %total, 1000
}
# ------------------------------------------------------------ #
```

In the above example pseudocode, the expval function, which returns an expectation value of a supplied observable, is removed and replaced with a surrounding for-loop, resulting in sampling of the quantum device and calculating an average.

As noted above, the optimizations at 330 or 340 can involve optimizing the quantum gradient of a quantum program. For example, the efficiency of quantum gradients can be optimized using dependency analysis operations.

An initial quantum program can be defined that requires to be differentiated with two differentiable parameters:

```
def circuit(x: float, y: float):
  RY(x, qubit=0)
  RY(y, qubit=1)
  CNOT(qubit=[1,2])
  return expval(PauliZ(qubit=0))
```

The above quantum program is an example of a quantum program representation that may be defined in a high-level language as referred to in 310.

The quantum program can then be translated to an intermediate representation:

```
func @circuit(%x: f32, %y: f32, %qubits: register<?>) −> f32 {
  %c0 = constant 0
  %c1 = constant 1
  %c2 = constant 2
  %q0 = quantum.extract %qubits[%c0]
  %q1 = quantum.extract %qubits[%c1]
  %q2 = quantum.extract %qubits[%c2]
  quantum.RY(%x) %q0
  quantum.RY(%y) %q1
  quantum.CNOT %q1, %q2
  return quantum.expval(“PauliZ”)
}
```

The above translation to a quantum MLIR representation is an example of an intermediate representation of a quantum program representation as referred to in 320.

The intermediate representation of the quantum program can then be optimized using auto-differentiation. The result of an auto-differentiation pass on the “circuit” function, using parameter-shift rules, can be as follows:

```
func @circuit_grad(%x: f32, %y: f32, %qubits: register<?>) −>
tensor<2xf32> {
  %c0 = constant 0
  %c1 = constant 1
  %half = constant 0.5
  %shift = constant 1.57079632679
  // parameter shift gradient of ‘x’
  %xs_p = numeric.addf %x, %shift
  %xs_m = numeric.subf %x, %shift
  %r0_p = call @circuit(%xs_p, %y, %qubits)
  %r0_m = call @circuit(%xs_p, %y, %qubits)
  %diff0 = numeric.subf %r0_p, %r0_n
  %g_x = numeric.mulf %diff0, %half
  // parameter shift gradient of ‘y’
  %ys_p = numeric.addf %y, %shift
  %ys_m = numeric.subf %y, %shift
  %r1_p = call @circuit(%x, %ys_p, %qubits)
  %r1_m = call @circuit(%x, %ys_m, %qubits)
  %diff1 = numeric.subf %r1_p, %r1_n
  %g_y = numeric.mulf %diff1, %half
  %gradient = tensor.from_elements %g_x, %g_y
  return %gradient
}
```

The above use of parameter-shift rules may provide a first part of the optimization of a portion of the intermediate representation.

After analysis of the original quantum program, it can be determined that the parameter ‘y’ has no effect on the computed result (the expectation value of qubit 0) and the intermediate representation can be further optimized by omitting the gradient computation with respect to ‘y’:

```
func @circuit_grad(%x: f32, %y: f32, %qubits: register<?>) −>
tensor<2xf32> {
  %c0 = constant 0
  %c1 = constant 1
  %half = constant 0.5
  %shift = constant 1.57079632679
  // parameter shift gradient of ‘x’
  %xs_p = numeric.addf %x, %shift
  %xs_m = numeric.subf %x, %shift
  %r0_p = call @circuit(%xs_p, %y, %qubits)
  %r0_m = call @circuit(%xs_p, %y, %qubits)
  %diff0 = numeric.subf %r0_p, %r0_n
  %g_x = numeric.mulf %diff0, half
  // gradient calculation of ‘y’ optimized away after analysis
  %g_y = constant 0.0
  %gradient = tensor.from_elements %g_x, %g_y
  return %gradient
}
```

Optionally, at 350 the intermediate representation can be further optimized. This optimization (or optimizations) can be done in a manner similar to those in 330 or 340. For example, the further optimizations at 350 can involve an iterative optimization process in which one or more of the optimizations from 330 and/or 340 are repeated.

Optionally, the intermediate representation of the high-level quantum program can be further optimized using a third set of optimization transformations associated with the first portion of the intermediate representation. For example, if the first portion is the numerical portion, then the third set of optimization transformations can further optimize the numerical portion of the intermediate representation.

Optionally, the intermediate representation of the high-level quantum program can be further optimized using a fourth set of optimization transformations associated with the second portion of the intermediate representation. For example, if the second portion is the quantum portion, then the fourth set of optimization transformations can further optimize the quantum portion of the intermediate representation.

For example, a sequence of different quantum optimization transformations may be performed to optimize the quantum portion of a quantum program. For example, a first quantum optimization transformation can be defined to merge multiple gates into a single rotation/phase gate, a second quantum optimization transformation can be defined to commute controlled operations, and a third quantum optimization transformation can be defined to cancel consecutive self-inverse operations.

Optionally, the optimization process can include an iterative optimization in which the first portion and/or the second portion are optimized multiple times. For example, one or both of the numerical portion and/or the quantum portion may be optimized multiple times.

Following the optimizations performed at 330 and 340 (and optionally 350), the resultant optimized version of the intermediate representation can be used to generate a lower-level intermediate representation of the quantum program. This lower-level intermediate representation can be used to generate a compiled quantum program that is ready for execution (e.g. as described in further detail herein below with reference to method 400).

Optionally, at 360 a new intermediate quantum program representation can be generated. The new intermediate quantum program representation can represent a new quantum program that is different from the original quantum program (e.g. the high-level representation received at 310).

The new intermediate quantum program representation can be generated as a result of the optimization of the intermediate representations performed at steps 330-340 (or 330-350). The optimizations can transform the quantum program into a new quantum program that is different from the original quantum program (defined in the high-level quantum representation).

The at least one new intermediate quantum program representation may include a plurality of new intermediate quantum program representations. The at least one new intermediate quantum program representation may include a transformed intermediate quantum program representation corresponding to a transformation of the original quantum program. For example, the quantum program may undergo multiple transformations during the optimization process (e.g. steps 330-360). Each new intermediate quantum program representation may represent a new quantum program that is different from the original quantum program as a result of the optimization transformations performed.

Referring now to FIG. 4, shown therein is an example method 400 for further optimizing a quantum program using a lower-level intermediate representation (IR). The method 400 may be used with a system for processing quantum programs such as the cloud-based system 100 for example. It should be understood that method 400 can also be used with other systems for processing quantum programs including non-cloud-based quantum execution systems. Depending on the particular implementation, the method 400 can be implemented by one or more components of the system 100, such as the server 104. The method 400 can be an addition to the method 300, for example, to further optimize a quantum computer program that was optimized using the method 300 for optimizing a quantum computer program using multi-level intermediate representations.

At 410, an optimized version of an intermediate representation of a quantum program representation can be received. The optimized version of the intermediate representation may be an intermediate representation of the quantum program generated at 340, 350, or 360.

At 420, at least one additional version of the intermediate representation can be determined. The at least one additional version can include a lower-level intermediate representation of the quantum program. The at least one additional version of the intermediate representation can be determined from the optimized version received at 420 (e.g. the second optimized version generated at step 340 of method 300 or the further optimized version generated at step 350 of method 300) of the intermediate representation.

At 430, the lower-level intermediate representation can be optimized. A third optimized version of the intermediate representation can be generated by optimizing the lower-level intermediate representation.

At 440, a compiled quantum program for execution can be generated. The compiled quantum program can be generated based at least in part on the third optimized version of the intermediate representation.

An example of pseudocode representing a lower-level intermediate representation is shown here:

```
# lower-level intermediate representation
func @circuit(%params: tensor<?xf32>, %qubits: register<?>) −>
tensor<f32> {
    # Structured control flow such as for loops and while loops
    # have been replaced by the basic block structure of control
    # flow graphs typical in low-level representations (such
    # as LLVM).
    cf.branch \hat{ }bb1(0, 0.0)
  \hat{ }bb1(%j, %total):
    %cond_j = numeric.isLessThan %j, 1000
    control.cond_branch %cond_j, \hat{ }bb2, \hat{ }bb6
  \hat{ }bb2:
    %ub = tensor.length %params
    control.branch \hat{ }bb3(0)
  \hat{ }bb3(%i):
    %cond_i = numeric.isLessThan %i, %ub
    control.cond_branch %cond_i, \hat{ }bb4, \hat{ }bb5
  \hat{ }bb4:
    %x = tensor.extract %params[%i]
    %y = numeric.multiply %x, %x
    %z = numeric.add %y, %x
    %new_z = numeric.add %z, PI
    quantum.RZ(%new_z) %qubits [0]
    quantum.CNOT %qubits[0], %qubits[1]
    %new_i = numeric.add %i, 1
    control.branch \hat{ }bb3(%new_i)
  \hat{ }bb5:
    %meas = quantum.measure %qubits[0]
    %new_total = numeric.add %total, %meas
    %new_i = numeric.add %i, 1
    control.branch \hat{ }bb1(%new_i, %new_total)
  \hat{ }bb6:
    return numeric.divide %total, 1000
}
```

In the pseudocode example shown above, structured control flow such as “for loops” and “while loops” have been replaced by the basic block structure of control flow graphs typical in low-level representations (such as LLVM for example).

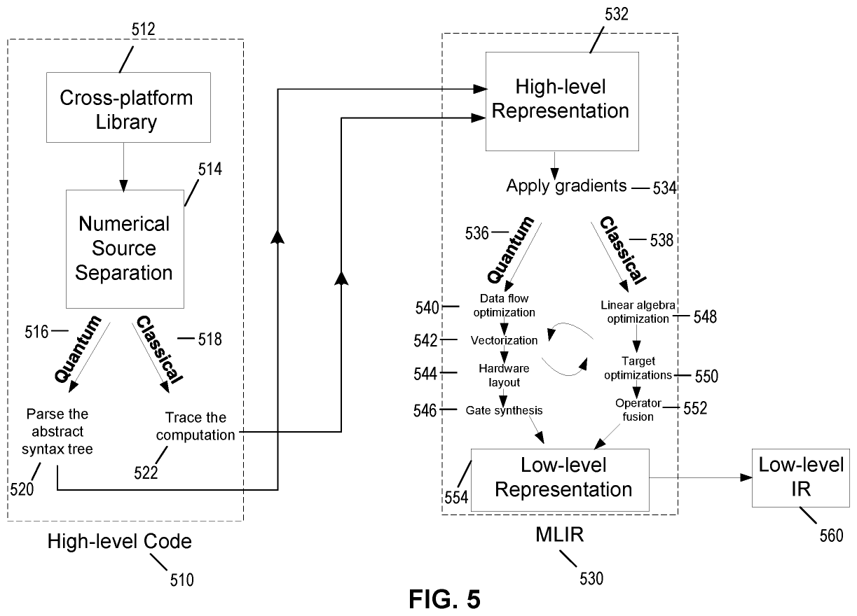

Referring now to FIG. 5, shown therein is a flowchart of an example program flow 500 for optimizing a quantum program using multi-level intermediate representations (IR). The program flow 500 may be used to show the program flow occurring during execution of the method 300 and/or the method 400.

In program flow 500, a quantum program is produced in high-level code 510 (e.g., a high-level programming language capable of representing quantum programs or hybrid quantum-classical programs, such as Python) for initial processing. The quantum program is optimized using a multi-level intermediate representation 530. After the quantum program is optimized, it is used as input into a low-level intermediate representation (IR) 560.

In the example high-level code block 510, the quantum program may be processed by a cross-platform library 512 (e.g., a Python library) for differentiable programming of quantum computers (such as PennyLane). Optionally, the cross-platform library 512 may also include resources (e.g., prewritten code) for machine learning. The quantum program can undergo numerical source separation 514. This separation includes quantum separation 516 and classical separation 518. The quantum separation 516 includes parsing the abstract syntax tree 520. The classical separation 518 includes tracing the computation 522. The results from this separation are used by the MLIR block 530.

In the MLIR block 530, a high-level representation 532 is obtained from the output of the high-level code block 510. The high-level representation can be obtained by parsing the abstract syntax tree 520 and tracing the computation 522. The high-level representation 532 may be subject to applying gradients 534. Applying of gradients can include a quantum branch 536 and a classical branch 536. The quantum branch 536 can include one or more of data flow optimization 540, vectorization 542, hardware layout 544, and/or gate synthesis 546. The classical branch 538 can include one or more of linear algebra optimization 548, target optimizations 550, and/or operator fusion 552. Although the quantum branch 536 and classical branch 538 are shown as separate parallel optimization branches, it should be understood that the optimizations performed under the quantum branch 536 and classical branch 538 can be interdependent and may be constrained by aspects of the program relating to the other branch. The results of the processing done under the quantum branch 536 and the classical branch 538 can then be used to determine a low-level representation 554.

The low-level IR block 560 obtains a low-level representation 554 from the output of the MLIR block 530. The low-level IR may be, for example, an LLVM IR.

One example of a program flow can be summarized as:
The high-level Python code, representing the hybrid quantum/classical model, is source-separated into quantum and classical components via computation tracing or abstract syntax tree parsing, before being converted into high-level MLIR.
Various optimization passes, interleaving quantum and classical processing, optimize the MLIR down to a low-level representation.
Finally, the MLIR is lowered down to the LLVM intermediate representation, for compilation into machine code.

The program flow 500 can be used by the system 100 to carry out part or all of method 300 and/or part or all of method 400.

The program flow 500 can be further described using the following examples:
IR optimizations for quantum gradients
Quantum and tensor library co-compilation
Higher level quantum operations
Vectorizing quantum-classical computations

### Quantum and Tensor Library Co-compilation

In order to compile more complex quantum programs which include numeric code, a “co-compilation” pipeline can be provided. In the co-compilation pipeline, a high-level quantum programming code (e.g., PennyLane code) can be compiled via a pipeline from the quantum program to the intermediate representation, and numeric code can be compiled via existing intermediate representation pipelines (such as MLIR pipelines provided by autodiff libraries, including, for example, JAX/TensorFlow/PyTorch MLIR pipelines). The code can then be re-stitched back together to create a hybrid model within MLIR. Using such a parallelized pipeline can provide for faster execution time.

This example (and the processes and/or pseudocode associated therewith) may be used by the system 100, for example, to carry out the generation of new intermediate quantum program representations in method 300 and/or to carry out the generation of a compiled quantum program in method 400.

For example, consider the following quantum function calling a JAX pure function:

```
@jax_fn(jnp.array(0.)) # give concrete shape of x to jax fn
def pure_jax_function(x):
  return x ** 2
@quantum_fn
def circuit(params: Annotated[jnp.Array, 1, jnp.float32]):
  for i in range(len(params)):
    RY(pure_jax_function(params[i]), qubit=i)
  return probs( )
```

Here, the high-level quantum circuit function is calling x ** 2 for the RY gate.

The JAX intermediate representation section can be generated by the JAX MHLO pipeline built into JAX:

```
func @pure_jax_function(%arg0: tensor<f32>) −> tensor<f32> {
  %0 = mhlo.multiply %arg0, %arg0 : tensor<f32>
  return %0 : tensor<f32>
}
```

The intermediate representation section can be generated by the pipeline:

```
func @circuit(%params: tensor<?xf32>, %qubits: register<?>) −>
tensor<?xf32> {
  %c0 = constant 0
  %lb = constant 0
  %st = constant 1
  %ub = tensor.dim %params, %c0
  control.for %i = %lb to %ub step %st {
    %x = tensor.extract %params[%i]
    %v = call @pure_jax_function(%x)
    quantum.RX(%v) %qubits[i]
  }
  return quantum.probs %qubits
}
```

### Numeric Source Separation

The approach shown in the last section can be extended to allow for mixing of numeric code and high-level quantum programming code (e.g., PennyLane code), by adding an additional “code separation step” via an abstract syntax tree (e.g., Python AST) source manipulation.

This example (and the processes and/or pseudocode associated therewith) may be used by the system 100, for example, to carry out the generation of new intermediate quantum program representations in method 300 and/or to carry out the generation of a compiled quantum program in method 400.

```
@quantum_fn
def circuit(params: Annotated[jnp.Array, 1, jnp.float32]):
  for i in range(len(params)):
    RY(params[i] ** 2, qubit=i)
  return probs( )
```

For example, the above may be source separated to:

```
@jax_fn(jnp.array(0.))
def jax_fn_1(x):
  return x ** 2
@quantum_fn
def circuit(params: Annotated[jnp.Array, 1, jnp.float32]):
  for i in range(len(params)):
    RY(jax_fn_1(params[i]), qubit=i)
  return probs( )
```

### Higher Level Quantum Operations

An MLIR dialect of a high-level quantum program (e.g., PennyLane MLIR dialect) can expand on other MLIR quantum dialects by including higher-level quantum statistical operations such as expval, var, probs. These operations can be decomposed into fundamental quantum operations via MLIR compiler passes.

This example (and the processes and/or pseudocode associated therewith) may be used by the system 100, for example, to carry out the generation of new intermediate quantum program representations in method 300 and/or to carry out the generation of a compiled quantum program in method 400.

Consider the quantum program as represented by the pseudocode shown here:

```
@quantum_fn
def circuit(theta: float):
  RY(theta, qubit=0)
  return expval(PauliZ(qubit=0))
```

This can be compiled to:

```
func @circuit(%theta: f64, %qubits: register<?>) {
  quantum.RX(%theta) %qubits[0]
  %ev = quantum.expval(“PauliZ”) %qubits[0]
  return %ev
}
```

Then a compiler pass can remove the expval operation by decomposing the expval operation into equivalent fundamental operations:

```
func @circuit(%theta: f64, %qubits: register<?>) −>
tensor<?xf32> {
  %lb = constant 0
  %st = constant 1
  %ub = constant 1000
  %total = constant 0.0
  control.for %i = %lb to %ub step %st {
    quantum.RX(%theta) %qubits[0]
    %m = quantum.measure %qubits[0]
    %total = numeric.add %total, %m
  }
  %out = numeric.divide %total, %ub
  return %out
}
```

### Vectorizing Quantum-Classical Computations

As shown in the MLIR block 530, gradients can be applied to a high-level representation of a quantum program (or hybrid quantum-classical program). This example provides a way of applying gradients to the quantum portion of the quantum program. This example provides a mechanism to vectorize quantum-classical functions, by using an MLIR compiler pass, and a new dialect operation (shown in this example as transform.vmap). Vectorization can be stated as the ability to create a quantum function that accepts inputs with arbitrary tensor shape, and later have the MLIR compiler optimize this down to multiple circuit executions in an efficient manner.

This example (and the processes and/or pseudocode associated therewith) may be used by the system 100, for example, to carry out the optimizations in method 300.

A quantum function, in Python, is shown as:

```
@quantum_fn
def circuit(theta: float):
  RY(theta, qubit=0)
  return expval(PauliZ(qubit=0))
@quantum_fn
def workflow( ):
  out = vmap(circuit) (tensor.ones((1000,)))
  return tensor.sum(out)
```

This quantum function may generate the MLIR:

```
func @circuit(%theta: f64) {
  %qubits = quantum.alloc(1) : register<1>
  quantum.RX(%theta) %qubits[0]
  %ev = quantum.expval(“PauliZ”) %qubits[0]
  return %ev
}
func @workflow( ) {
  %angles = tensor.ones( ) : tensor<1000xf32>
  %out = transform.vmap @circuit(%angles)
  %res = tensor.sum(%out)
  return %res
}
```

After the proposed compiler pass, the vmap operation can be removed:

```
func @vmap_circuit(%theta: tensor<1000xf32>) {
  %lb = constant 0
  %st = constant 1
  %ub = constant 1000
  %result = tensor.allocate(%ub) : tensor<1000xf32>
  control.for %i = %lb to %ub step %st {
    %theta_i = tensor.extract %theta[%i]
    quantum.RX(%theta_i) %qubits[0]
    %ev = quantum.expval(“PauliZ”) %qubits[0]
    tensor.store %ev, %result[%i]
  }
  return %result
}
func @workflow( ) {
  %angles = tensor.ones( ) : !tensor<1000xf32>
  %out = call @vmap_circuit(%angles)
  %res = tensor.sum(%out)
  return %res
}
```

While the above description provides examples of one or more processes or apparatuses or systems, it will be appreciated that other processes or apparatuses or systems may be within the scope of the accompanying claims.

It will be understood that the example described in this disclosure and the module, routine, process, thread, or other software component implementing the described methods/processes/frameworks may be realized using standard computer programming techniques and languages. The present application is not limited to particular processors, computer languages, computer programming conventions, data structures, other such implementation details. Those skilled in the art will recognize that the described methods/processes may be implemented as a part of computer-executable code stored in volatile or non-volatile memory, as part of an application-specific integrated chip (ASIC), etc.

As will be apparent to a person of skill in the art, certain adaptations and modifications of the described methods/processes/frameworks can be made, and the above discussed examples should be considered to be illustrative and not restrictive.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

We claim:

1. A method comprising:
determining an intermediate representation of a high-level quantum program representation defined in a high-level programming language, the intermediate representation comprising a first portion and a second portion;
optimizing the intermediate representation by optimizing the first portion of the intermediate representation according to a first set of optimization transformations associated with the first portion of the intermediate representation, thereby generating a first optimized version of the intermediate representation;
further optimizing the intermediate representation by optimizing the second portion of the intermediate representation according to a second set of optimization transformations associated with the second portion of the intermediate representation, thereby generating a second optimized version of the intermediate representation;
wherein
one of the first portion or the second portion is an intermediate numerical representation usable to optimize numerical characteristics of the high-level quantum program representation; and
the other of the first portion or the second portion is an intermediate quantum representation usable to optimize quantum characteristics of the high-level quantum program representation.

2. The method of claim 1, further comprising:
further optimizing the intermediate representation of the high-level quantum program using a third set of optimization transformations associated with the first portion of the intermediate representation.

3. The method of claim 2, further comprising:
further optimizing the intermediate representation of the high-level quantum program using a fourth set of optimization transformations associated with the second portion of the intermediate representation.

4. The method of claim 1, wherein optimizing the second one of the first portion of the intermediate representation and the second portion of the intermediate representation comprises generating at least one new intermediate quantum program representation, each new intermediate quantum program representation representing a new quantum program that is different from an original quantum program corresponding to the high-level quantum program representation.

5. The method of claim 4, wherein the at least one new intermediate quantum program representation includes a transformed intermediate quantum program representation corresponding to a transformation of the original quantum program.

6. The method of claim 1, further comprising:
determining at least one additional version of the intermediate representation of the high-level quantum program from the second optimized version of the intermediate representation, the at least one additional version of the intermediate representation including a lower-level intermediate representation; and
generating a third optimized version of the intermediate representation by optimizing the lower-level intermediate representation.

7. The method of claim 6, further comprising:
generating a compiled quantum program for execution based at least in part on the third optimized version of the intermediate representation.

8. The method of claim 1, wherein the intermediate numerical representation is defined to directly represent differentiable tensor values.

9. The method of claim 1, wherein the high-level quantum program representation represents a hybrid quantum-classical program.

10. The method of claim 9, wherein at least one of the optimization transformations comprises computing a gradient of both the classical portion and quantum portion of the hybrid quantum-classical program.

11. The method of claim 1, wherein the intermediate representation includes control flow data and the optimization transformations are performed taking into account the control flow data.

12. The method of claim 11, wherein the control flow data is modified by at least one of the optimization transformations.

13. A non-transitory computer readable medium storing computer-executable instructions, which, when executed by a computer processor, cause the computer processor to carry out a method comprising:
determining an intermediate representation of a high-level quantum program representation defined in a high-level programming language, the intermediate representation comprising a first portion and a second portion;
optimizing the intermediate representation by optimizing the first portion of the intermediate representation according to a first set of optimization transformations associated with the first portion of the intermediate representation, thereby generating a first optimized version of the intermediate representation;
further optimizing the intermediate representation by optimizing the second portion of the intermediate representation according to a second set of optimization transformations associated with the second portion of the intermediate representation, thereby generating a second optimized version of the intermediate representation;
wherein
one of the first portion or the second portion is an intermediate numerical representation usable to optimize numerical characteristics of the high-level quantum program representation; and
the other of the first portion or the second portion is an intermediate quantum representation usable to optimize quantum characteristics of the high-level quantum program representation.

14. The computer readable medium of claim 13, wherein the method further comprises:
further optimizing the intermediate representation of the high-level quantum program using a third set of optimization transformations associated with the first portion of the intermediate representation.

15. The computer readable medium of claim 14, wherein the method further comprises:
further optimizing the intermediate representation of the high-level quantum program using a fourth set of optimization transformations associated with the second portion of the intermediate representation.

16. The computer readable medium of claim 13, wherein optimizing the second one of the first portion of the intermediate representation and the second portion of the intermediate representation comprises generating at least one new intermediate quantum program representation, each new intermediate quantum program representation representing a new quantum program that is different from an original quantum program corresponding to the high-level quantum program representation.

17. The computer readable medium of claim 16, wherein the at least one new intermediate quantum program representation includes a transformed intermediate quantum program representation corresponding to a transformation of the original quantum program.

18. The computer readable medium of claim 13, wherein the method further comprises:
determining at least one additional version of the intermediate representation of the high-level quantum program from the second optimized version of the intermediate representation, the at least one additional version of the intermediate representation including a lower-level intermediate representation; and
generating a third optimized version of the intermediate representation by optimizing the lower-level intermediate representation.

19. The computer readable medium of claim 18, wherein the method further comprises:
generating a compiled quantum program for execution based at least in part on the third optimized version of the intermediate representation.

20. The computer readable medium of claim 13, wherein the intermediate numerical representation is defined to directly represent differentiable tensor values.

21. The computer readable medium of claim 13, wherein the high-level quantum program representation represents a hybrid quantum-classical program.

22. The computer readable medium of claim 21, wherein at least one of the optimization transformations comprises computing a gradient of both the classical portion and quantum portion of the hybrid quantum-classical program.

23. The computer readable medium of claim 13, wherein the intermediate representation includes control flow data and the optimization transformations are performed taking into account the control flow data.

24. The computer readable medium of claim 23, wherein the control flow data is modified by at least one of the optimization transformations.
